(19) United States
(12) Patent Application Publication
(10) Pub. No.: US 2016/0075011 A1
(43) Pub. Date: Mar. 17, 2016

(54) ROBOT APPARATUS

(71) Applicants: HONG FU JIN PRECISION INDUSTRY (ShenZhen) CO.,LTD., Shenzhen (CN); HON HAI PRECISION INDUSTRY CO., LTD., New Taipei (TW)

(72) Inventor: YUN ZHAO, Shenzhen (CN)

(21) Appl. No.: 14/564,665

(22) Filed: Dec. 9, 2014

(30) Foreign Application Priority Data
Sep. 12, 2014 (CN) 201410463438.3

(51) Int. Cl. B25J 9/00

(52) U.S. Cl. CPC B25J 9/0096; Y10S 901/21

(57) ABSTRACT

A robot apparatus includes a main body, a driving mechanism, a guide mechanism, and a sealed belt. The guide mechanism includes a working table, a guide frame, a first guide wheel, two second guide wheels, and two adjustment assemblies to adjust a height of the first guide wheel relative to the guide frame. The first guide wheel is parallel with and located between the two second guide wheels. The adjustment assembly includes a guide shaft and an elastic member to elastically resist against the first guide wheel and guide shaft. The sealed belt passes through the first guide wheel and two second guide wheels. Either the first guide wheel or the second guide wheel is resisted against the sealed belt in the direction away from the working table, and a remaining is resisted against the sealed belt in the direction toward the working table.

### FIELD

The subject matter herein generally relates to an industrial robot apparatus.

### BACKGROUND

As developments in manufacturing technology progress, robot apparatuses are increasingly applied to perform functions in environments considered hazardous or difficult for operators. Especially, the robot apparatuses having perfect dust-proof properties are greatly popular in industrial manufacturing by reason of the hazardous application environment. Thus, it is usually necessary to attach a sealed belt made of metal, rubber or the like to the robot apparatus to prevent foreign materials, such as chips of cutting, cutting oil, dust or the like from entering the robot apparatus body.

### BRIEF DESCRIPTION OF THE DRAWINGS

Implementations of the present technology will now be described, by way of example only, with reference to the attached figures.

FIG. 1 is an isometric view of an embodiment of a robot apparatus.

FIG. 2 is a partial, exploded view of the robot apparatus shown in FIG. 1.

FIG. 3 is a partial, exploded view of a guide mechanism of the robot apparatus shown in FIG. 2.

FIG. 4 is an assembly view of the guide mechanism shown in FIG. 3.

FIG. 5 is a cross-sectional view of the robot apparatus shown in FIG. 1 taken along line V-V.

FIG. 6 is a cross-sectional view of the robot apparatus shown in FIG. 1 taken along line VI-VI.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising”, when utilized, means “including, but not necessarily limited to”; it specifically indicates open-ended inclusion or membership in the so-described combination, group, series and the like.

The present disclosure is described in relation to a robot apparatus 100.

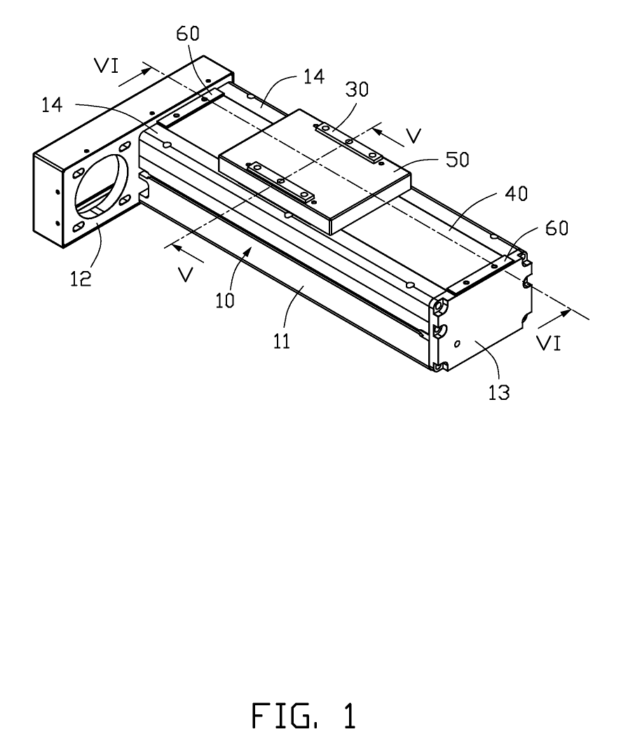

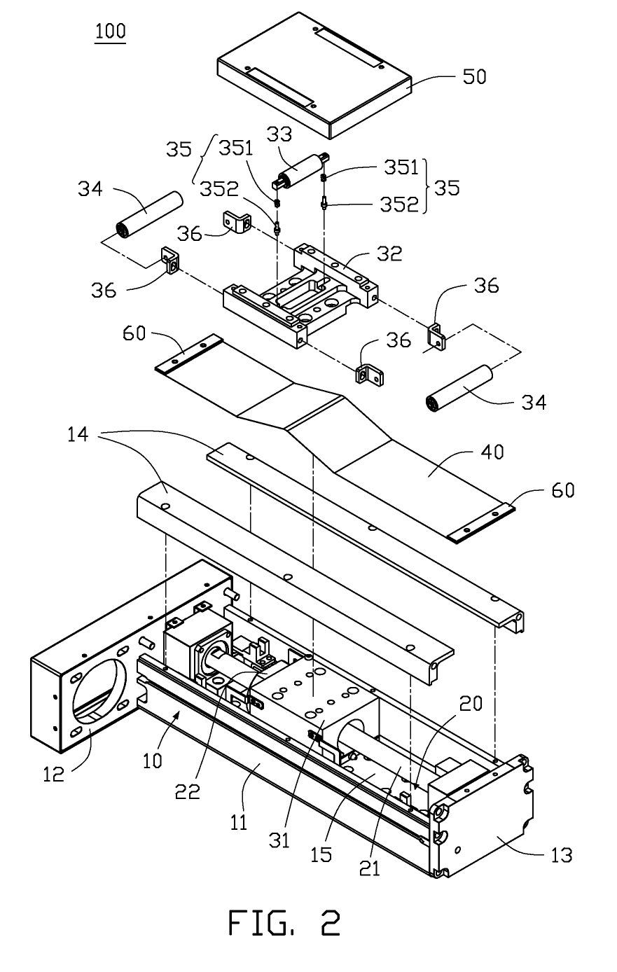

FIGS. 1-2 illustrate that a robot apparatus 100 can include a main body 10, a driving mechanism 20 installed on the main body 10, a guide mechanism 30, a sealed belt 40 configured to seal the driving mechanism 20 inside the main body 10, and a cover 50 coupled to the guide mechanism 30.

The main body 10 can include a base 11, an installation plate 12 installed on the base 11, a fastening plate 13 positioned facing the installation plate 12, and two side plates 14 coupled to the base 11 and positioned between the installation plate 12 and the fastening plate 13. The installation plate 12 and the fastening plate 13 can be positioned parallel with each other. The installation plate 12 and the fastening plate 13 can be substantially perpendicular to the two side plates 14. The main body 10 can further define a receiving space 15 cooperatively formed by the base 11, the installation plate 12, the fastening plate 13 and the two side plates 14, and the receiving space 15 is configured to receive the driving mechanism 20.

The driving mechanism 20 can include a shaft 21, and a wheel 22 coiled on and coupled to the shaft 21. The shaft 21 can be substantially perpendicular to the installation plate 12 and the fastening plate 13. The shaft 21 can be rotatably positioned on the installation plate 12 and can pass through the installation plate 12. The installation plate 12 can be configured to install a motor connected to the shaft 21 to drive the shaft 21.

The wheel 22 can be threadedly connected to the shaft 21 and can be moved by the shaft 21 in an axial direction of the shaft 21 with a rotation of the shaft 21.

The guide mechanism 30 can include a working table 31, a guide frame 32, a first guide wheel 33, two second guide wheels 34, two adjustment assemblies 35, and four adjustment frames 36. The adjustment assembly 35 can be configured to adjust a height of the first guide wheel 33 relative to the guide frame 32. The adjustment frame 36 can be adjustably connected to the guide frame 32 and the second guide wheel 34.

The working table 31 can be a hollow block and can be positioned adjacent to the wheel 22. The working table 31 can be connected to the wheel 22 and can be coiled on the shaft 21. The working table 31 can be moved by the wheel 22 in the axial direction of the shaft 22.

The guide frame 32 can be connected to the working table 31. In one embodiment, the first guide wheel 33 and the second guide wheel 34 can be formed by a bearing and a shaft coupled to the bearing. The adjustment assembly 35 can include an elastic member 351 and a guide shaft 352.

The sealed belt 40 can be positioned between the two side plates 14 and can abut against the two side plates 14. The sealed belt 40 can be substantially parallel with the shaft 21, configured to seal the driving mechanism 20 inside the main body 10.

The robot apparatus 100 further include two fastening members 60 configured to fasten the sealed belt 40 on the installation plate 12 and the fastening plate 13. In one embodiment, the two fastening members 60 can be connected to either opposite end of the sealed belt 40 on the installation plate 12 and the fastening plate 13. An end of the sealed belt 40 adjacent to the installation plate 12 can be fastened on the installation plate 12 by one fastening member 60, and an end of the sealed belt 40 adjacent to the fastening plate 13 can be fastened on the fastening plate 13 by one remaining fastening member 60. Therefore, the driving mechanism 20 can be insulated against materials such as oil, dust, or water or the like, to realize a reserved operation life.

The cover 50 can be positioned on the guide mechanism 30 and can be connected to the guide frame 32, configured to cover the guide mechanism 30. A shape and size of the cover 50 can match the guide frame 32.

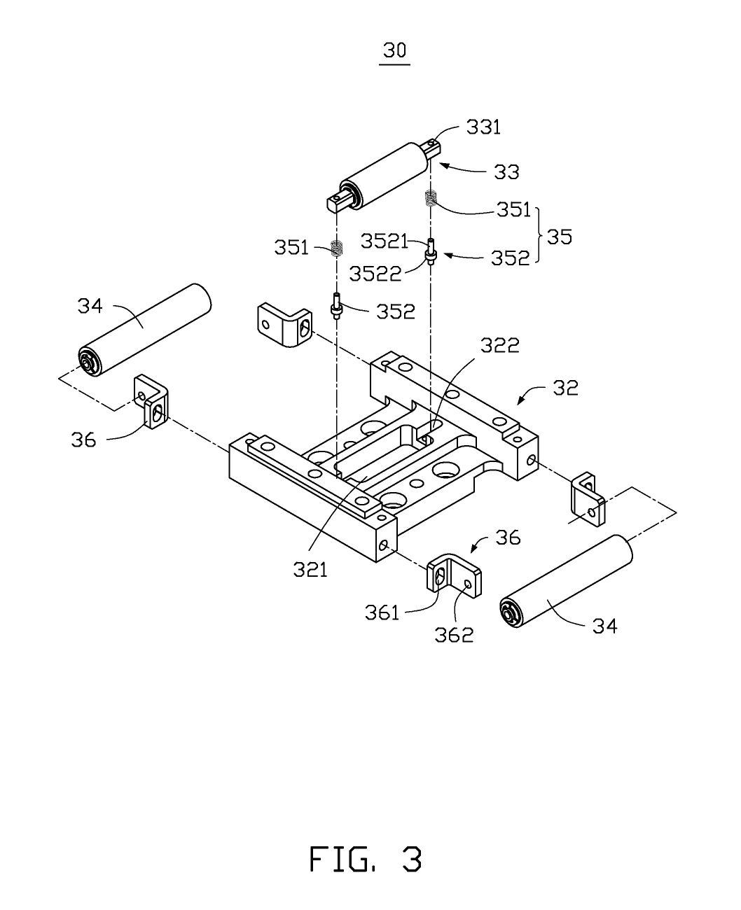

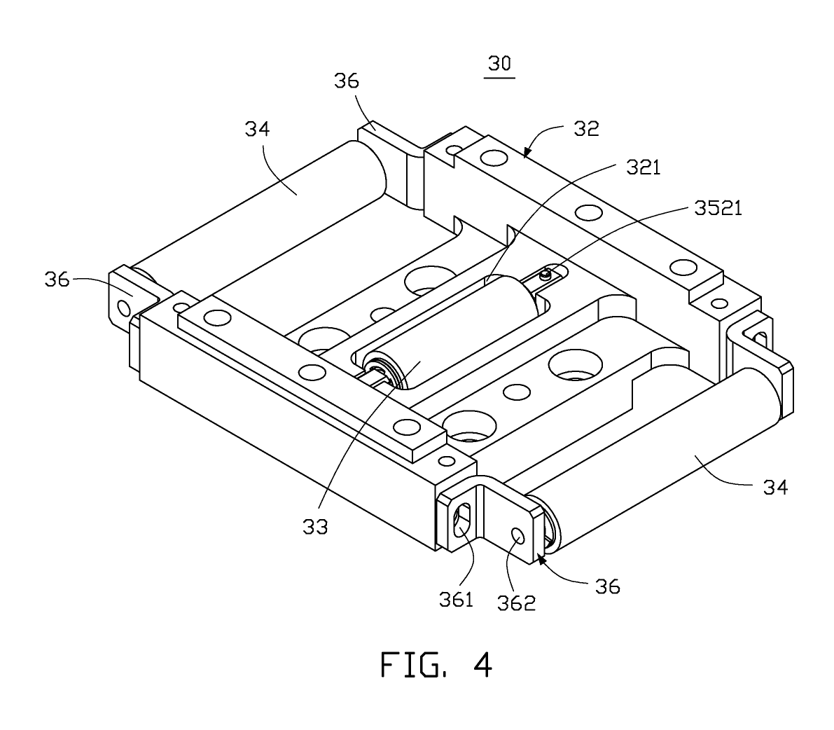

FIGS. 3-4 illustrate the guide frame 32 can be H-shaped and can define a recess portion 321 in the middle of the guide frame 32, two blind holes 322 on either opposite end of the guide frame 32. The shape and size of the recess portion 321 can match the first guide wheel 33 and can be configured to receive the first guide wheel 33. The recess portion 321 can be spaced from the two second guide wheels 34. The two blind holes 322 can be defined on either opposite end of the guide frame 32 adjacent to the recess portion 321.

The first guide wheel 33 can define two guide holes 331 facing to the two blind holes 322. The two guide holes 331 can be defined on either opposite end of the first guide wheel 33. The axial direction of the guide hole 331 can be parallel with the blind hole 322.

The two second guide wheels 34 can be positioned parallel with the recess portion 321 and the recess portion 321 can be located between the two second guide wheels 34. The first guide wheel 33 can be received in the recess portion 321. The first guide wheel 33 can be located between the two second guide wheels 34 parallel with the second guide wheel 34.

The elastic member 351 of the adjustment assembly 35 can be hollow, and can be substantially cylinder. The elastic member 351 can be elastically resisted against the guide shaft 352 and the first guide wheel 33. In one embodiment, the elastic member 351 can be a cylinder spring.

The guide shaft 352 can include a shaft portion 3521 and a protrusion portion 3522 connected to the shaft portion 3521. The protrusion portion 3522 can be ring-shaped and can be located between either opposite end of the shaft portion 3521. The axial direction of the shaft portion 3521 and the protrusion portion 3522 can be parallel with the guide hole 331 and the blind hole 322.

An end of the shaft portion 3521 adjacent to the first guide wheel 33 can be positioned in the elastic member 351 and the guide hole 331. An end of the shaft 3521 away from the first guide wheel 33 can be received in the blind hole 322 and can abut against an bottom of the blind hole 322. In one embodiment, the shaft portion 3521 can be integrated with the protrusion portion 3522. The elastic member 351 can be coiled on the shaft portion 3521. The elastic member 351 can be located between and elastically resisted against the first guide wheel 33 and the protrusion portion 3522.

The height of the first guide wheel 33 relative to the guide frame 32 can be adjusted with a compression state change of the elastic member 351. The height of the first guide wheel 33 relative to the guide frame 32 can be reduced when the elastic member 351 is compressed. In the contrary, the height of the first guide wheel 33 relative to the guide frame 32 can increase when the elastic member 351 rebounds.

In one embodiment, the end of the shaft portion 3521 adjacent to the elastic member 351 can be exposed outside the first guide wheel 33 through the guide hole 331 when the elastic member 351 is compressed.

The adjustment frame 36 can be L-shaped. An end of the adjustment frame 36 can be fastened to the second guide wheel 34 and an end away from the second guide wheel 34 can be adjustably connected to the guide frame 32.

The adjustment frame 36 can define an adjusting hole 361 positioned on an end of the adjustment frame 36 adjustably connected to the guide frame 32. The adjusting hole 361 can be oval. A longer axial direction of the adjusting hole 361 can be perpendicular to the guide frame 32. The adjustment frame 36 can further define a substantially circular fastening hole 362 configured to fasten the second guide wheel 34.

In one embodiment, the four adjustment frames 36 can be adjustably connected to the guide frame 32 by screws or the like passing through the adjusting hole 361. The second guide wheel 34 can be fastened on two ends of the guide frame 32 via the adjustment frame 36 by the fastening hole 362. The height of the second guide wheel 34 relative to the guide frame 32 can be adjusted by an adjust of the height of the screws through the adjusting hole 361 in the longer axial direction of the oval adjusting hole 361.

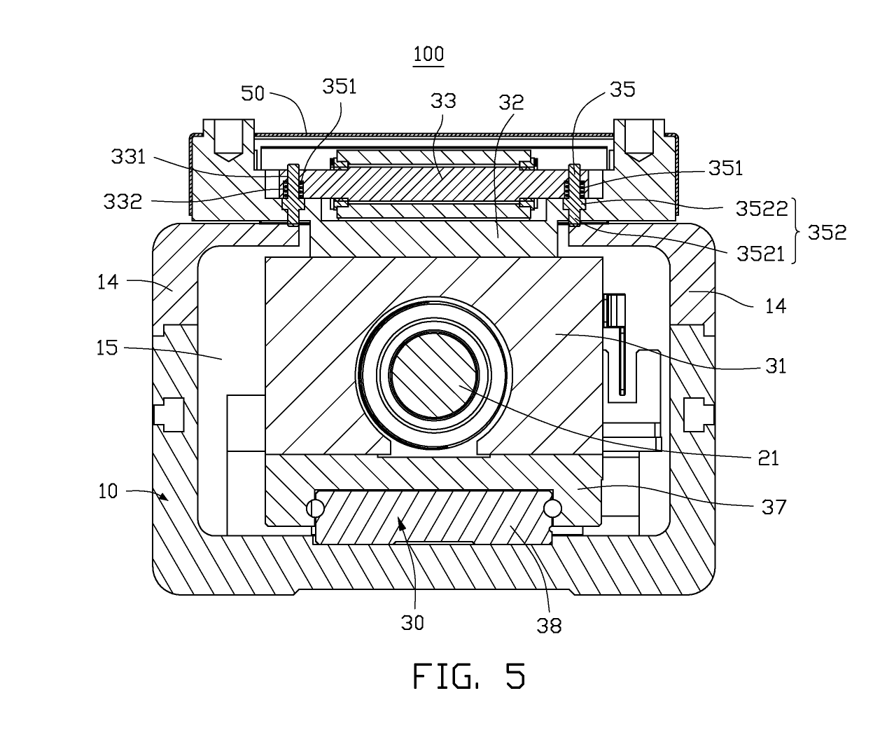

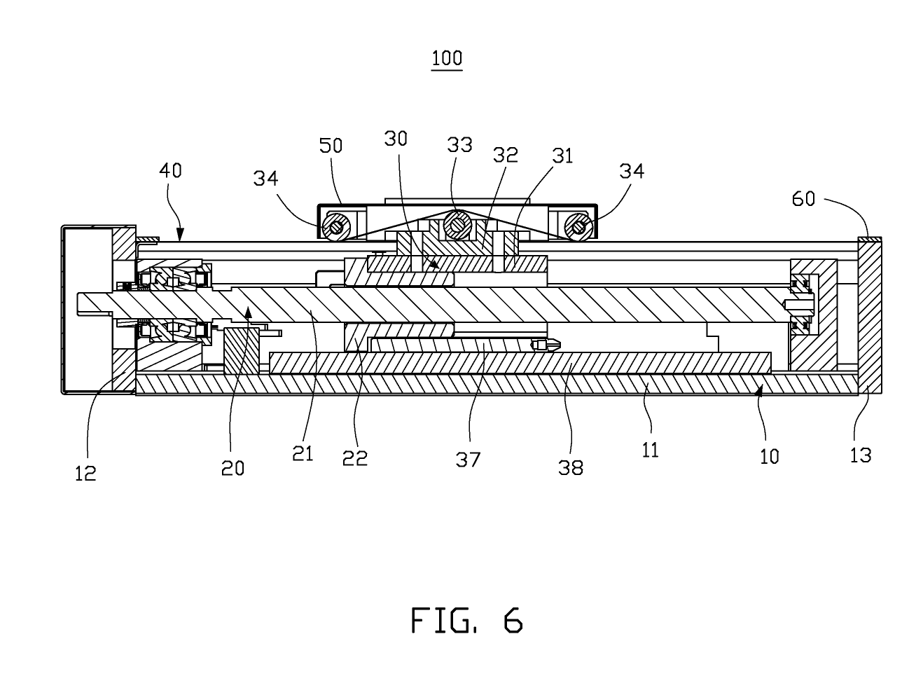

FIGS. 5-6 illustrate that the guide mechanism 30 can further include a sliding member 37 connected to the working table 31, and a guide rail 38 positioned adjacent to the sliding member 37. The sliding member 37 can be slidingly installed on the guide rail 38. The guide rail 38 can be parallel with the shaft 21. The sliding member 37 can be moved by the working table 31 in the direction parallel with the axial direction of the shaft 21 on the guide rail 38, with the wheel 22 connected to the working table 31.

The first guide wheel 33 can further include a receiving hole 332 connected to the guide hole 331. The shape and size of the receiving hole 332 can match the elastic member 351 configured to receive the elastic member 351. A diameter of the receiving hole 332 can be larger than the guide hole 331 configured to avoid the elastic member 351 sliding to the guide hoe 331.

In one embodiment, the first guide wheel 33 can be resisted against an inner side of the sealed belt 40 in the direction away from the working table 31, and the two second guide wheels 34 can be resisted against an outside side of the sealed belt 40 in the direction toward the working table 31. The inner side of the sealed belt 40 can be a side of the sealed belt 40 adjacent to the working table 31, and the outside side of the sealed belt 40 can be the side of the sealed belt 40 away from the working table 31. In other embodiments, the first guide wheel 33 can be resisted against the outside side of the sealed belt 40 in the direction toward the working table 31, and the two second guide wheels 34 can be resisted against the inner side of the sealed belt 40 in the direction away from the working table 31.

The first guide wheel 33 can adjust a tenseness state of the sealed belt 40 by adjusting the height relative to the guide frame 32. Furthermore, the second guide wheel 34 can certain that the sealed belt 40 is always attached to the second guide wheel 34 by adjusting the height relative to the guide frame 32.

In operation, a workpiece can be positioned on the cover 50, and the shaft 21 can be driven by the motor to rotate around the axial direction of the shaft 21. The wheel 22 can moved with the shaft 21 in the axial direction of the shaft 21, and the working table 31 connected to the wheel 22 can be moved by the wheel 22. Further more, the guide frame 32 can simultaneously make a rolling movement with the working table 31 via the first guide wheel 33 and the second guide wheel 34. In this situation, a rolling friction between the first, second guide wheel (33, 34) and the guide frame 32 can be smaller relative to a sliding friction.

In assembly, the guide rail 38 can be installed on the bottom of the main body 10, and the wheel 22 can be installed on the shaft 21. The working table 31 can be connected to the wheel 22. Then, the installation plate 12 and the fastening plate 13 can be installed on either opposite end of the main body 10. The shaft 21 can be connected to and located between the installation plate 12 and the fastening plate 13. The guide frame 32 can be fastened on the working table 31 and the first, second guide wheel (33, 34) can be installed on the guide frame 32. The sealed belt 40 can be positioned passing through one of the second guide wheel 34, the first guide wheel 33, another second guide wheel 34 in order. Two ends of the sealed belt 40 can be fastened on the installation plate 12 and the fastening plate 13 by the fastening numbers 60. The cover 50 can be positioned on the guide frame 32 and can be connected to the guide frame 32.

The embodiments shown and described above are only examples. Many details are often found in the art such as the other features of a robot apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A robot apparatus comprising:
a main body;
a driving mechanism inside the main body;
a guide mechanism driven by the driving mechanism, the guide mechanism comprising:
a working table connected to the driving mechanism;
a guide frame positioned on the working table;
a first guide wheel and two second guide wheels installed on the guide frame, the first guide wheel positioned parallel with and located between the two second guide wheels; and
two adjustment assemblies configured to adjust a height of the first guide wheel relative to the guide frame, the adjustment assembly comprising:
a guide shaft; and
an elastic member configured to elastically resist against the first guide wheel and the guide shaft; and
a sealed belt configured to seal the driving mechanism inside the main body, the sealed belt positioned passing through the first guide wheel and the two second guide wheels;
wherein, either the first guide wheel or the two second guide wheels can be resisted against an inner side of the sealed belt in the direction away from the working table, and a remaining can be resisted against an outside side of the sealed belt in the direction toward the working table.

2. The robot apparatus as claimed in claim 1, wherein, the guide shaft includes a shaft portion and a protrusion portion connected to the shaft portion.

3. The robot apparatus as claimed in claim 2, wherein, the elastic member is coiled on the shaft portion, and is resisted against and located between the first guide wheel and the protrusion portion.

4. The robot apparatus as claimed in claim 2, wherein, the guide frame defines a recess portion positioned in the middle of the guide frame and the first guide wheel is received in the recess portion.

5. The robot apparatus as claimed in claim 4, wherein, the guide frame defines two blind holes on either opposite end of the guide frame adjacent to the recess portion.

6. The robot apparatus as claimed in claim 5, wherein, the first guide wheel defines two guide holes facing to the two blind holes.

7. The robot apparatus as claimed in claim 6, wherein, the first guide wheel further defines a receiving hole connected to the guide hole configured to receive the elastic member, and a diameter of the receiving hole is larger than the guide hole.

8. The robot apparatus as claimed in claim 7, wherein, an end of the shaft portion adjacent to the elastic member is received in the guide hole and the receiving hole, and the end of the shaft portion away from the elastic member is received in and resisted against the blind hole.

9. The robot apparatus as claimed in claim 1, wherein, the guide mechanism further includes four adjustment frames adjustably connected to the guide frame, and each one of the two second guide wheels is connected to the guide frame by each two of the four adjustment frames.

10. The robot apparatus as claimed in claim 9, wherein, the adjustment frame is L-shaped, and each one of the four adjustment frames defines an oval adjusting hole positioned on an end of the adjustment frame adjustably connected to the guide frame.

11. The robot apparatus as claimed in claim 10, wherein, a longer axial direction of the adjusting hole is substantially perpendicular to the guide frame.

12. The robot apparatus as claimed in claim 1, wherein, the driving mechanism further includes a shaft rotatably positioned in the main body, and a wheel connected to the shaft moved by the shaft in an axial direction of the shaft.

13. The robot apparatus as claimed in claim 12, wherein, the working table is coiled on the shaft connected to the wheel and the working table can be moved by the wheel in the axial direction of the shaft.

14. The robot apparatus as claimed in claim 1, wherein, the guide mechanism further includes a sliding member connected to the working table and a guide rail adjacent to the sliding member parallel with the shaft, and the sliding member is slidingly positioned on the guide rail.
